(19) United States
(12) Patent Application Publication
(10) Pub. No.: US 2004/0228478 A1
(43) Pub. Date: Nov. 18, 2004

(54) Countermeasure method in an electronic component using a public key cryptographic algorithm on an elliptic curve

(76) Inventor: Marc Joye, Saint Zacharie (FR)

Correspondence Address: BURNS DOANE SWECKER & MATHIS L L P, POST OFFICE BOX 1404, ALEXANDRIA, VA, 22313-1404, US

(21) Appl. No.: 10/475,174

(22) PCT Filed: Apr. 25, 2002
(86) PCT No.: PCT/FR02/01434

(30) Foreign Application Priority Data
Apr. 27, 2001 (FR) 01 05759

(51) Int. Cl. H04L 9/00

(52) U.S. Cl. 380/28

(57) ABSTRACT

A countermeasure method in an electronic component uses a public key cryptographic algorithm on a specific elliptic curve E on a body IK. An exponential computation of Q=d.P type is carried out, where P and Q are points of the specific elliptic curve E, and d is a predetermined number. A non-null random number u is selected which is an element of the finite body IK, to define randomly an isomorphic elliptic curve Eu′. Co-ordinates of a point P′ on the isomorphic elliptic curve Eu′ are calculated which are an image of the point P. An exponentiation algorithm is applied to the point image P′ on the isomorphic elliptic curve Eu′, to obtain a resulting point Q′. Co-ordinates on the specific elliptic curve E of point Q, which is a pre-image of the resulting point Q′, are then computed.

The present invention concerns a countermeasure method in an electronic component using a public key cryptographic algorithm on an elliptic curve.

Public key algorithms on an elliptic curve allow cryptographic applications of the encryption, signature verification, authentication, etc. type.

They are in particular widely used in smart card applications, since they make it possible to use keys of short length, enabling fairly short processing times, and they may not require the use of cryptoprocessors for their implementation, which reduces the production cost of the electronic components in which they are implemented.

As a reminder, if IK is a field, the set of points (x,y) ε IK×IK verifying the general Weierstrass equation: y²+a1xy+a3y=x³+a2x²+a4x+a6, with ai ε IK, and the point at infinity 0 forms an elliptic curve. Any elliptic curve over a field can be expressed in this form.

The set of points (x,y) and the point at infinity form an abelian group, in which the point at infinity is the neutral element and in which the group operation is point addition, denoted+ and given by the well-known chord-and-tangent rule. In this group, the pair (x,y), where the abscissa x and the ordinate y are elements of the field IK, forms the affine coordinates of a point P on the elliptic curve.

It should be noted that, in a finite field, the number of elements in the field is always expressed in the form pⁿ, where p is a prime number. p is the characteristic of the field.

Two classes of elliptic curve are more particularly used in cryptographic systems: those defined over a finite field of characteristic p different from 2 and 3 and those defined over a field of characteristic equal to 2.

For elliptic curves of the first class, the Weierstrass equation simplifies into:

y²=x³+ax+b

And for those of the second class, being restricted to non-supersingular curves, this equation becomes:

y²+xy=x³+ax²+b.

For each of these two classes of curve, point addition and doubling operations have been defined. Formulae for these operations are given in many references known to persons skilled in the art. These formulae are detailed later in the text, in the case of an elliptic curve defined over a field of characteristic different from 2 or 3.

These operations are at the root of exponentiation algorithms on these elliptic curves: given a point P belonging to an elliptic curve and d a predetermined number (an integer), the result of the scalar multiplication of the point P by the multiplier d is a point Q on the curve such that Q=d.P=P+P+. . . +P d times.

Public key cryptographic algorithms on an elliptic curve are thus based on the scalar multiplication of a selected point P on the curve by a predetermined number d, the secret key. The result of this scalar multiplication d.P is a point Q on the elliptic curve. In an example application to encryption according to the El Gamal method, the point Q obtained is the public key which is used for encrypting a message.

However, public key cryptographic algorithms on an elliptic curve have proved to be sensitive to attacks aiming to discover in particular the value of the secret key. Simple or differential hidden channel attacks can be cited in particular.

Simple or differential hidden channel attack means an attack based on a physical quantity measurable from outside the device, and whose direct analysis (simple attack) or analysis according to a statistical method (differential attack) makes it possible to discover information contained and manipulated in processing operations in the device. These attacks can thus make it possible to discover confidential information. These attacks have in particular been revealed by Paul Kocher (Advances in Cryptology—CRYPTO′99, vol. 1966 of Lecture Notes in Computer Science, pp. 388-397. Springer-Verlag, 1999). Amongst the physical quantities which can be used for these purposes, current consumption, electromagnetic field, etc. can be cited. These attacks are based on the fact that the manipulation of a bit, that is to say its processing by a particular instruction, has a particular print on the physical quantity considered according to its value.

In cryptographic systems based on elliptic curves, these attacks are aimed at scalar multiplication.

Calculation of the scalar multiplication Q=d.P can be carried out by various exponentiation algorithms. A few of them can be cited, such as the double and add algorithm based on binary representation of the multiplier d, that of add-subtract based on signed binary representation of the multiplier d, the window algorithm, etc. All these algorithms use double and add operation formulae defined on elliptic curves.

In all these algorithms, countermeasure methods have had to be provided making it possible to prevent the various attacks from succeeding. In other words, an attempt has been made to make these algorithms secure. For example, the well-known so-called double and add algorithm is in particular sensitive to simple hidden channel attacks, since it comprises an operation conditional on the value of a bit of the secret key d. In order to make this algorithm secure, it has been transformed into the so-called double with systematic add algorithm. In this algorithm, irrespective of the value of the bit of the secret key in the processing in progress, the same operations, and the same number of them, are always carried out. In general terms, it is known how to make these algorithms secure with regard to simple attacks, by removing all branches conditional on the value of the data item processed.

However, it was possible to show that these security countermeasures did not protect from differential hidden channel attacks, by which it was possible to discover the secret key d.

An effective security countermeasure to differential attacks is to randomise the inputs and/or outputs of the exponentiation algorithm used to calculate Q=d.P. In other words, it is a matter of making the multiplier d and/or the point P random.

Countermeasure methods applying this principle are known. Such countermeasure methods are in particular described in an article by Jean-Sebastien Coron (Cryptographic Hardware and Embedded Systems, volume 1717 of Lecture Notes in Computer Science, pages 292-302. Springer-Verlag, 1999).

In particular, in this article, a countermeasure method consists of masking the point P by using randomly defined projective coordinates of this point.

A point on the elliptic curve E (different from the point at infinity) is in fact defined uniquely on this curve by its affine coordinates (x,y). But this point can be represented by projective coordinates (X:Y:Z) and an exponential number of representations in projective coordinates exists.

In the countermeasure method described, a random number t IK is thus drawn and the point P is represented by projective coordinates which are a function of this random number.

In the aforementioned article, it is proposed to advantageously form the projective coordinates of the point P as a function of the random number t and the affine coordinates, for example in the form P=(tx:ty:t) in homogeneous projective coordinates, or P=(t²x:t³y:t) in Jacobian coordinates. The exponentiation algorithm is applied to these coordinates. A representation of the point Q is obtained in projective coordinates, from which the affine coordinates of this point are deduced (calculated).

One object of the present invention is a countermeasure method, in particular with regard to differential hidden channel attacks.

Another object of the invention is a countermeasure method which is easy to use.

Compared with the aforementioned article, the proposed method has the advantage of being faster and of being applicable equally well in affine and projective coordinates.

The idea at the root of the invention is to use group isomorphisms, in order to transpose the scalar multiplication calculations onto an elliptic curve E_u obtained by application of a group isomorphism φᵤ, defined with respect to a non-zero random number u, an element of the field IK.

In other words, the countermeasure method then consists of drawing a non-zero random number u, in order to define a random isomorphic elliptic curve E_u =φᵤ (E), of calculating the coordinates of the image point on this curve E_u of the point P, of applying the exponentiation algorithm to this image point P′ on the isomorphic elliptic curve E_u, in order to obtain a resultant point Q′, and of calculating the coordinates of the pre-image point Q of the point Q′ on the elliptic curve E on which the cryptographic system is based.

As the algebraic structure of elliptic curves is very rich, numerous isomorphism definition possibilities exist, so that the countermeasure method according to the invention is of very general application.

The invention therefore concerns a countermeasure method in an electronic component using a public key cryptographic algorithm on a given elliptic curve E over a field IK, comprising an exponentiation calculation of the type Q=d.P where P and Q are points on the given elliptic curve (E), and d a predetermined number, characterised in that it comprises the following steps:

drawing a non-zero random number u, an element of the field IK, in order to randomly define an isomorphic elliptic curve E_u;

calculating the coordinates of a point P′ on the said isomorphic elliptic curve E_u, the image of the point P;

applying an exponentiation algorithm to the said image point P′ on the said isomorphic elliptic curve E_u, in order to obtain a resultant point Q′;

calculating the coordinates on the given elliptic curve E of the point Q, the pre-image of the resultant point Q′.

Other characteristics and advantages of the invention are presented in the following description, given with reference to one particular embodiment, for elliptic curves over a field IK of characteristic different from 2 or 3.

It has been seen that an elliptic curve over such a field can be defined as follows: E/_{IK}: y²=x³+ax+b.

Let E1 and E2 be two elliptic curves defined over such a field:

E1/_{IK}:y²=x³+ax+b

E2/_{IK}:y²=x³+a′x+b′

It can be shown that these two curves are isomorphic over IK if and only if there exists a non-zero number u belonging to IK such that u⁴a′=a and u⁶b′=b.

If φ denotes the group isomorphism such that E2=φ (E1), it can be shown that, to any point P=(x,y) on the elliptic curve E1, there corresponds an image point φ (P)=P′=(x′,y′) on the elliptic curve E2 such that:

x′=u⁻²x and y′=u⁻³y.

Conversely, by application of the inverse isomorphism φ⁻¹ such that φ⁻¹ (E2)=E1, to any point P′=(x′,y′) on the elliptic curve E2, there corresponds a pre-image point φ⁻¹ (P′)=P=(x,y) on the elliptic curve E1 such that:

x=u²x′ and y=u³y′.

In the invention, use is made of the group isomorphism applied to elliptic curves, in order to randomly mask the point P to which the exponentiation algorithm is applied.

Therefore let there be an exponentiation algorithm of the type Q=d.P, where Q and P are points on a defined elliptic curve E. The countermeasure method according to the invention therefore consists of randomly drawing a number u from the non-zero elements of the field IK, in order to randomly define an isomorphic elliptic curve E_u=φᵤ (E). The coordinates of the image point P′ of the point P on this isomorphic elliptic curve E_u are calculated and this image point P′ is applied to the input of the exponentiation algorithm. A resultant point Q′ on the isomorphic elliptic curve E_u is obtained. The coordinates of the pre-image point Q of the resultant point Q′ on the defined elliptic curve E are then calculated. In other words, according to this method, the following is calculated:

Q=φ⁻¹ (d (φ(P))).

By means of this method, the number u being random, the intermediate calculation steps of the exponentiation algorithm are unpredictable.

This method can be applied to any exponentiation algorithm of one's choosing and in the system of coordinates, affine or projective, of one's choosing. In particular, the point P′=(x′1,y′1) can be represented by projective coordinates P′=(X:Y:Z), with the Z coordinate equal to 1, that is: P′=(x′1:y′1:1).

An exponentiation algorithm in projective coordinates (homogeneous or Jacobian) of one's choosing is then used. With the Z coordinates being equal to 1, the number of operations for calculating d.P′ is then reduced.

Preferably, a random value u is drawn each time the cryptographic algorithm is called upon.

In another variant embodiment, a random value u is drawn at the personalisation of the electronic component. This value is then stored in a rewritable memory portion of the electronic component, as the secret key d. In this case, provision can be made to pre-calculate certain values, in order to speed up the processing. In the example embodiment more particularly described on finite fields of characteristic different from 2 or 3, the value u⁻¹ can in particular be pre-calculated, which makes it possible to calculate the coordinates of the points P′ and Q′, and it will be stored in rewritable memory. This is in particular advantageous in applications in which the processing speed is very important, and in which the rewritable memory has sufficient capacity.

A detailed explanation can be given of the countermeasure method according to the invention, applied to a cryptographic system based on an elliptic curve E defined over a finite field of characteristic different from 2 or 3, in order to perform an exponentiation of the type Q=d.P, where Q and P are points on the elliptic curve E and d a predetermined number. d and P are the inputs and Q the output of the exponentiation algorithm.

In such an example, it has been seen that the Weierstrass equation for the elliptic curve E over the field IK is written:

E/_{IK}:y²=x³+ax+b.

In this curve, the operation of point addition of P=(x₁,y₁) and Q=(x₂,y₂) (with Q≠−P) gives a point R=(x₃,y₃)=P+Q such that: x₃=λ²−x₁−x₂ and y₃=λ (x₁−x₃)−y₁

with λ=(y₂−y₁)/(x₂−x₁), if P≠Q (formula 1)

and λ=(3x₁²+a)/2y₁, if P=Q (formula 2).

Formula 1 is the formula for addition of 2 distinct points: R=Q+P, whilst formula 2 is the formula for doubling of the point: R=2.P.

It should be noted that neither of these formulae uses the parameter b of the equation of the elliptic curve E.

Thus, a countermeasure method applied to an elliptic curve defined by the Weierstrass equation of the type y²=x³+ax+b, and to an exponentiation algorithm applied to a point P=(x1,y1) using operations of doubling of a point and of addition between two points on this curve E, can be written as follows:

a) Randomly drawing a non-zero number u;

b) Evaluating the parameter a′=u⁻⁴a of the Weierstrass equation of the type y²=x³+a′x+b′ defining an isomorphic elliptic curve E_u of the elliptic curve E;

c) Forming the point P′=(u⁻²x₁, u⁻³y₁);

d) Calculating the point Q′=d.P′ on the isomorphic elliptic curve E_u;

e) If the resultant point Q′ is the point at infinity, the point Q is the point at infinity,

Otherwise setting Q′=(x′₃, y′₃)

f) Returning Q=(U²x′₃, u³y′₃) as the pre-image point.

Remarkably, the calculation of the point Q+dP′ at the step d) of this method can be performed with the algorithm of one's choosing, and in the coordinate system of one's choosing. In particular the use of projective coordinates (homogeneous or Jacobian) for the point P′ 4 is particularly advantageous if P′ is represented with its Z coordinate equal to 1 since the number of operations for calculating d P′ is then reduced. This then gives P′=(u⁻²x1:u⁻³y1:1).

The countermeasure method according to the invention can be generalised. In particular, the elliptic curves can be given by parameterisations other than those of Weierstrass.

In general terms, the step b) of the method detailed above thus consists of calculating parameters of the isomorphic elliptic equation, from the random number u and the parameters of the elliptic curve on which the cryptographic system is based. Only the parameters used in the operations on the elliptic curve (addition of two points, doubling) need to be calculated. In the example detailed above, only the parameter a needs to be calculated.

Moreover, the countermeasure method can be applied to the various exponentiation algorithms of the prior art, since it only transposes this algorithm onto another elliptic curve. Thus, this countermeasure method can be used in all cryptographic systems on an elliptic curve. It applies in particular to electronic components intended for smart cards.

1. A countermeasure method in an electronic component using a public key cryptographic algorithm on a given elliptic curve E over a field IK, of the type employing an exponentiation calculation of the type Q=d.P where P and Q are points on the given elliptic curve (E), and d is a predetermined number, comprising the following steps:
drawing a non-zero random number u, an element of the field IK, to randomly define an isomorphic elliptic curve E_u;
calculating the coordinates of a point P′ on said isomorphic elliptic curve E_u, which is the image of the point P;
applying an exponentiation algorithm to said image point P′ on said isomorphic elliptic curve E_u, to obtain a resultant point Q′; and
calculating the coordinates on the given elliptic curve E of the point Q, which is the pre-image of the resultant point Q′.

2. A countermeasure method according to claim 1, wherein the definition of the isomorphic elliptic curve E_u comprises the calculation of parameters of said curve as a function of the parameters of the elliptic curve E and of said random variable, said parameters being used in said exponentiation algorithm.

3. A countermeasure method according to claim 1, wherein said exponentiation algorithm is applied to the image point P′ in affine coordinates.

4. A countermeasure method according to claim 1, wherein said exponentiation algorithm is applied to the image point P′ in projective coordinates.

5. A countermeasure method according to claim 4, wherein said projective coordinates are of the type with the Z coordinate equal to 1.

6. A countermeasure method according to claim 2, wherein the elliptic curve E is defined by the equation y²=x³+ax+b, and the exponentiation algorithm applied to a point P=(x1,y1) includes operations of doubling of a point and of addition or subtraction between two points on said curve E, and further including the following steps:
a) Randomly drawing a non-zero number u;
b) Evaluating the parameter a′=u⁻⁴a in the equation y²=x³+a′x+b′, defining an isomorphic elliptic curve E_u to the elliptic curve E;
c) Forming the image point P′=(u⁻²x₁, u⁻³y₁) of the point P on said isomorphic curve E_u;
d) Calculating the resultant point Q′=d.P′ by application of said exponentiation algorithm on said isomorphic elliptic curve E_u;
e) If the point Q′ is equal to the point at infinity, returning the point at infinity as the image point Q,
Otherwise setting Q′=(x′₃, y′₃); and
f) Returning Q=(u²x′₃, u³y′₃).

7. A countermeasure method according to claim 6, wherein said exponentiation algorithm is applied at step d) to projective coordinates (X:Y:Z) of the point P′ formed at step c) by P′=(u⁻²x₁:u⁻³y₁:1).

8. An electronic component which performs a countermeasure method using a public key cryptographic algorithm on a given elliptic curve E over a field IK, in which an exponentiation calculation of the type Q=d.P where P and Q are points on the given elliptic curve (E), and d is a predetermined number, is carried out with the following steps:
drawing a non-zero random number u, an element of the field IK, to randomly define an isomorphic elliptic curve E_u;
calculating the coordinates of a point P′ on the said isomorphic elliptic curve E_u, which is the image of the point P;
applying an exponentiation algorithm to said image point P′ on said isomorphic elliptic curve E_u, to obtain a resultant point Q′; and
calculating the coordinates on the given elliptic curve E of the point Q, which is the pre-image of the resultant point Q′.

9. A smart card comprising an electronic component according to claim 8.
